(19) United States
(12) Patent Application Publication
(10) Pub. No.: US 2025/0077735 A1
(43) Pub. Date: Mar. 6, 2025

(54) Low-voltage System Design and Modeling

(71) Applicant: Fady Ishak, Fort Worth, TX (US)

(72) Inventor: Fady Ishak, Fort Worth, TX (US)

(21) Appl. No.: 18/740,257

(22) Filed: Jun. 11, 2024

Related U.S. Application Data
(60) Provisional application No. 63/535,056, filed on Aug. 28, 2023.

(51) Int. Cl. G06F 30/20; G06F 30/10

(52) U.S. Cl. CPC G06F 30/20; G06F 30/10

(57) ABSTRACT

Techniques are disclosed for the design and modeling of a low-voltage system or network. The low-voltage system is currently or prospectively deployed in a building/site. For this purpose, a schematic diagram and a corresponding 3D model are created for the low-voltage network. The schematic diagram is integrated with the 3D model. As a result, the latter is fully aware of the choices of low-voltage devices, port configurations, connections between the exact ports of the devices and the cable-types for the connections for the low-voltage system being designed. This leads to a number of advantages for the designers/modelers of low-voltage systems. The system can also calculate voltage-drops in connections as well as potential overload conditions. Such error detection capabilities allow the user to take proactive actions at the design stage of the low-voltage system in order to circumvent problems during its operation and after deployment.

### RELATED APPLICATIONS

This application claims priority from U.S. Provisional Patent Application No. 63/535,056 filed on Aug. 28, 2023 and which is incorporated by reference herein for all purposes in its entirety.

### FIELD OF THE INVENTION

The present invention generally relates to construction/manufacturing modeling systems and more specifically to the design and modeling of low-voltage systems.

### BACKGROUND

In the modern era of architectural design and construction, Building Information Modeling (BIM) software plays a pivotal role in streamlining the process of conceptualization, planning, and implementation. Low-voltage systems, such as Fault Managed Power (FMP) and Power over Ethernet (PoE) have emerged as powerful technologies, providing power and data connectivity over a single Ethernet cable. However, the design and modeling of such low-voltage systems remains a challenge.

There is plenty of prior art that has attempted to address the challenges and needs of the industry. U.S. Patent Publication No. US 2023/0153477 A1 to Somu discloses embodiments that include an interface processing system for displaying interrelated hierarchical building system models. The interface processing system can include memory and a processor allocation to load an executable asset from a data store to instantiate an instance of a building management service. The service can receive from a client application executing an operator interface on a client device, a request to display a visual representation of an asset located in a building.

The above service can query an asset database including structured data associated with the asset. Location data can be used to generate a digital model of a building system location associated with the asset. The building management service can retrieve structured model data for the asset and system level components and extract. These are retrieved from a set of asset schemas, a hierarchical relationship between the asset, locations and the system level components to generate an interactive visual representation of the building system location.

U.S. Patent Publication No. US 2021/0232724 A1 to Tierney discusses a method for defining a route for a connecting medium through a three-dimensional building. This involves modeling the three-dimensional building as a two-dimensional array of panels, wherein any two panels in the array of panels are connected panels. This happens if a connecting medium can be directly routed from one panel to the other panel, a set of coordinates for each of one or more panels in the array of panels where a connecting medium can enter or exit the panel, and a union of the respective set of coordinates for each of the one or more connected panels in the array of panels where a connecting medium can be routed between the connected panels. The process selects one or more panels in the array through which to route the connecting medium based on the unions of the respective set of coordinates for each of the one or more connected panels in the array of panels.

U.S. Patent Publication No. US 2017/0315697 A1 to Jacobson teaches systems, methods, and modes for on-demand rendering of a three-dimensional building management system visualization of a building. The system comprises a database configured for storing geometry elements and spatial elements. The geometry elements are mapped to spatial elements, wherein the geometry elements define three-dimensional geometrical representation of a building's structure, and the spatial elements define three-dimensional representation of spaces in the building. The spatial elements are associated with respective space nodes that identify the spaces located within the building, and the space nodes are associated with respective electronic devices installed within the spaces in the building. The system further comprises at least one processor configured for selectively recalling the geometry elements and spatial elements from the database, and rendering a three-dimensional building visualization of the building via a user interface, wherein the three-dimensional building visualization comprises a status information visualization of at least one electronic device.

U.S. Patent Publication No. 2021/0073449 A1 to Segev discloses systems and methods for selecting equipment for use in buildings. The system may include at least one processor configured to perform operations that include accessing a floor plan demarcating a plurality of rooms. The operations further include accessing functional requirements associated with the rooms and accessing technical specifications associated with the functional requirements. The operations include performing floor plan analysis on the floor plan to ascertain room features associated with the functional requirements and technical specifications.

The above operations also include generatively analyzing the room features to determine a customized equipment configuration for at least some of the rooms, and generating a manufacturer dataset including a room identifier, an equipment identifier, and the customized equipment configuration. The manufacturer dataset enables a manufacturer to customize equipment for the rooms and package the customized equipment to display the room identifier.

The plugin for Autodesk® Revit® entitled “Electric Low Voltage Power Cables E.L.V.P.C. R2023” purports to give the ability to add low-voltage electric power cables by type and instance and standards for more flexibility in drawing and counting. The plugin contains more than five hundred low-voltage Engineering, Procurement, and Construction (EPC) and cable parameters. These include overall diameter, bend radius, insulation type and material according to British Standard (BS) and International Electrotechnical Commission (IEC) as indicated in the plugin database.

Despite the above attempts, there is no prior art that allows for the design of a low-voltage system such that its schematic diagram is fully integrated with the 3D model. There is also no prior art is which the correct ports and cable-types are automatically identified in the 3D model based on the schematic diagram. There is also no prevailing art that performs load calculations and simulations on the low-voltage network such that any unacceptably high voltage-drops and overload conditions are proactively identified.

### OBJECTS OF THE INVENTION

In view of the shortcomings of the prior art, it is an object of the invention to provide techniques for the design and modeling of low-voltage systems, including Power over Ethernet (PoE) systems, fault managed power (FMP) systems, distributed antenna systems (DAS), closed-circuit television (CCTV) systems, fire-alarm systems, paging systems, audio-visual (A/V) systems, data networks, secure entry systems and physical intrusion detection systems (IDS).

It is further and object of the invention to implement the above techniques such that the schematic diagram of the low-voltage system/network is integrated with its 3D model.

It is another object of the invention to automatically identify the correct ports and cable-types in the 3D model based on the integration between the schematic diagram and the 3D model.

It is also an object of the invention to calculate the voltage-drop in the connections and alert the user if the voltage-drop is unacceptably high.

It is another object of the invention to perform load calculations and proactively alert the user if any low-voltage device is overloaded.

It is further an object of the invention to implement these techniques as a plugin for Revit® BIM system by Audodesk®.

It is further an object of the invention to implement these techniques as a standalone system.

### SUMMARY OF THE INVENTION

A number of objects and advantages of the invention are achieved by apparatus and methods for designing and modeling a low-voltage system or network according to the instant principles. The low-voltage system/network being designed is either currently or prospectively deployed in a building or site. The term low-voltage in the present disclosure subsumes the industry accepted definitions of low-voltage (LV) systems as well as extremely low voltage (ELV) systems. Thus, the scope of the present technology includes LV and ELV systems as known in the art, and we use the term low-voltage system/network to refer to either or both of them or any other low-voltage system.

The design and modeling, or simply put, the design of a low-voltage system entails a user creating a schematic diagram and a corresponding three-dimensional (3D) model of the low-voltage system being designed. The 3D model is also sometimes referred to as the building information modeling (BIM) model or a 3D/BIM model.

The present technology is preferably implemented as a plugin or an add-in to an existing BIM system, preferably Autodesk Revit®. However, alternatively, it may be implemented as a standalone system. There is preferably a schematic module in the instant system/plugin that is responsible for the creation and maintenance of the low-voltage schematic diagram by the user. The user role in charge of the schematic diagram is typically referred to as the “designer” user although that is not necessary. Thus, with the aid of the schematic module of an instant low-voltage design system/plugin, the user creates the schematic diagram for the low-voltage system/network.

For this purpose, the user includes/adds the various low-voltage devices in the schematic diagram that will be realized as physical devices to be deployed in the building and as part of the eventual/physical low-voltage system. The user can choose such devices with their specifications from devices that already exist in a component or device library of the system. Alternatively, the user can create new devices with the requisite specs as needed. Appropriate GUI affordances are provided in the graphical user interface (GUI) of the schematic module for this purpose.

The user also creates the various connections between devices as will be need for the low-voltage network. More specifically, each connection is created between a port of a first device to a port of a second device. A corresponding 3D/BIM model of the schematic diagram is also created by the user for the eventual/physical low-voltage network. In the preferred embodiment, there is 3D modeler module or simply a 3D module that is responsible for the creation and maintenance of the 3D/BIM model by the user. The user role in charge of the 3D model is typically referred to as the “modeler” user although that is not a requirement.

Thus, the schematic diagram and the 3D model of the eventual/physical low-voltage system are created by the user of the instant technology, preferably by a designer using the instant schematic module and a modeler using the instant 3D module respectively. According to the chief aspects, the schematic diagram created above is fully integrated with or “married to” the corresponding 3D/BIM model of the low-voltage network. What this means is that each element, whether it is a device or a connection or any other element, is associated or mapped to a corresponding 3D element in the 3D model of the low-voltage network.

The above integration is accomplished because the user “associates” each element in the schematic diagram to its counterpart in the 3D model. Unless such an association is made, an alert symbol, preferably an exclamation mark (!), is shown in the unassociated element in the schematic diagram. Therefore, the user associates each device and connection in the schematic to their counterparts in the 3D model. Now, there may be a number or a set of input and output ports on each device. For any given connection, the user chooses the exact ports on the first/second devices that the connection is between, as are intended for the eventual low-voltage system being designed. The user also associates the desired cable-type for each connection in the schematic diagram.

Once the above-discussed association between the devices and their 3D counterparts has been made and based on the choice of ports for the connections on the schematic diagram, the 3D module automatically identifies the correct ports on the 3D devices in the 3D model for routing the cable for the corresponding 3D connections. The instant low-voltage design system and preferably its 3D modeling module picks the correct cable-type for the connection that will eventually be realized or deployed at a site or building. It does so based on the above-discussed association of schematic elements to their 3D counterparts.

At this point, the 3D model contains the correct 3D devices as well as the correct ports between which the 3D connections are made while utilizing the correct cable-types. Consequently, the system knows the exact length of each cable for each connection. Based on the above information, the system computes an expected drop in voltage to the endpoint devices from their respective drivers or their nearest powering devices. If the voltage-drop is below a preconfigured acceptable level, an alert is raised for the user. The user can now modify the design of the low-voltage system to alleviate or overcome or compensate for the voltage-drop.

The user may do so by choosing a lower or thicker gauge wire for the cable-type of the connection. Alternatively, or in addition, the user may change the location of the device such that the length of the cable to it is shorter. Still alternatively or in addition, the user may choose a different device that is more tolerant of the voltage-drop. In any case, the user can take proactive actions at the design stage of the low-voltage system such that critical downstream problems are avoided once the low-voltage system becomes operational. This is a key advantage of the present design.

The instant low-voltage technology also performs a load analysis of the low-voltage system being designed. Based on the load analysis it determines the expected load on each device based on a number of criteria. If a device is expected to be overloaded under one or more of various overload conditions, an alert is raised for the user who can then take remedial actions. Once again, such corrective actions can be performed at the design stage of the low-voltage system, thus circumventing critical problems once the low-voltage system has been deployed. This is another key contribution of the present design.

Depending on the embodiment, the routing of 3D connections is performed either manually or automatically. The automatic routing capability is highly advantageous and is also referred to as “auto-routing”. The present design can perform auto-routing because it knows the exact devices, ports and cable-types for each connection in the 3D model. It can therefore automatically route the cable in the 3D model on a viable routing path or connection.

A variety of low-voltage systems with a variety of low-voltage devices can benefit from the present low-voltage design technology. Exemplary low-voltage devices include low-voltage power supplies, Power over Ethernet (PoE) switches, PoE drivers, low-voltage lighting equipment, PoE injectors and PoE appliances. Exemplary low-voltage systems include Power over Ethernet (PoE) systems, fault managed power (FMP) systems, distributed antenna systems (DAS), closed-circuit television (CCTV) systems, fire-alarm systems, paging systems, audio-visual (A/V) systems, data networks, secure entry systems and physical intrusion detection systems (IDS).

In another preferred embodiment, the instant design system can also generate a bill of materials (BOM) for the low-voltage system being designed. It can do so because it already knows the types and numbers of each element in the eventual low-voltage system. In other words, it knows the devices as well as the length and cable-types for each connection per above teachings.

In a highly preferred embodiment, the instant low-voltage design system is integrated with a building monitoring system (BMS). For this purpose, the datapoints of the building or site where the low-voltage system is deployed are imported into the BMS. In addition, an overall 3D model also referred to as a digital asset is also imported into the BMS. The digital asset contains the instant 3D model for the low-voltage system deployed in the building. The user of the BMS then maps each low-voltage datapoint in the building to the corresponding element in the instant 3D model.

Once the above is accomplished, any incident arising with a low-voltage element including a low-voltage device or cable in the building is instantly identified in real-time or near real-time in the BMS. A maintenance worker can then be dispatched to address the fault with the implicated low-voltage element as needed. It is then important to the update the instant schematic diagram and the 3D model for the low-voltage system to reflect current state of the deployed low-voltage system. Such integration with BMS for instant identification of problems with low-voltage systems is another contribution of the present technology.

The apparatus of the present invention include a computer system comprising computer-readable instructions stored in a non-transitory storage medium and at least one microprocessor coupled to said non-transitory storage medium for executing said computer-readable instructions, said at least one microprocessor configured to: (a) enable a user to interactively create a schematic diagram and a corresponding three-dimensional (3D) model of a low-voltage system for a building, wherein said schematic diagram comprises a connection between a port on a first device and a port on a second device; (b) perform an integration of said schematic diagram with said 3D model by associating said first device, said second device and said connection to their corresponding counterparts in said 3D model; (c) automatically identify in said 3D model based on said integration, said port on said first device from amongst a set of ports on said first device and said port on said second device from amongst a set of ports on said second device; (d) perform a routing in said 3D model of a cable with an associated cable-type for forming said connection, said connection realized by installing said cable in said building; (e) enable said user to interactively perform a modification of said schematic diagram and said 3D model for alleviating a voltage-drop based on said cable-type and a length of said cable; and (f) perform a load analysis of said low-voltage system and alert said user if a potential load on any of said first device and said second device is expected to exceed a rated maximum value.

The methods of the present invention include a computer-implemented method comprising the steps of: (a) interactively creating by a user, a schematic diagram and a corresponding three-dimensional (3D) model of a low-voltage system for a building, said low-voltage system comprising a connection between a port on a first device and a port on a second device;
(b) integrating said schematic diagram with said 3D model by associating said first device, said second device and said connection to their corresponding counterparts in said 3D model;
(c) automatically identifying in said 3D model based on said integration, said port on said first device from amongst a set of ports on said first device and said port on said second device from amongst a set of ports on said second device; (d) routing in said 3D model, a cable with an associated cable-type for forming said connection, said connection realized by installing said cable in said building; (e) interactively modifying by said user, said schematic diagram and said 3D model for alleviating a voltage-drop based on said cable-type and a length of said cable; and (f) performing a load analysis of said low-voltage system and alerting said user if a potential load on any of said first device and said second device is expected to exceed a rated maximum value.

Clearly, the systems and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 illustrates an environment containing an instant low-voltage design system that is being used to design an actual or physical low-voltage system/network that is currently or prospectively deployed in a building or site.

FIG. 2 illustrates a block-diagram view of a preferred embodiment containing a schematic module and a 3D modeling module or simply a 3D module.

FIG. 3A-D show various sections/portions of a screenshot of a schematic diagram for a low-voltage system being designed.

FIG. 4A-B show sections/portions of a screenshot of a 3D model corresponding to the schematic diagram of FIG. 3.

FIG. 5 shows a power data table generated from the schematic diagram of FIG. 3.

FIG. 6 illustrates a block-diagram view of a preferred embodiment that is integrated with a building monitoring system (BMS) based on the instant techniques.

FIG. 7A-I show sections/portions of various screenshots of schematic diagrams of low-voltage systems being designed in order to elucidate the many features of the present technology.

FIG. 8A-D show sections/portions of various screenshots of schematic diagrams of low-voltage systems being designed in order to elucidate the many error detection capabilities of the present technology.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

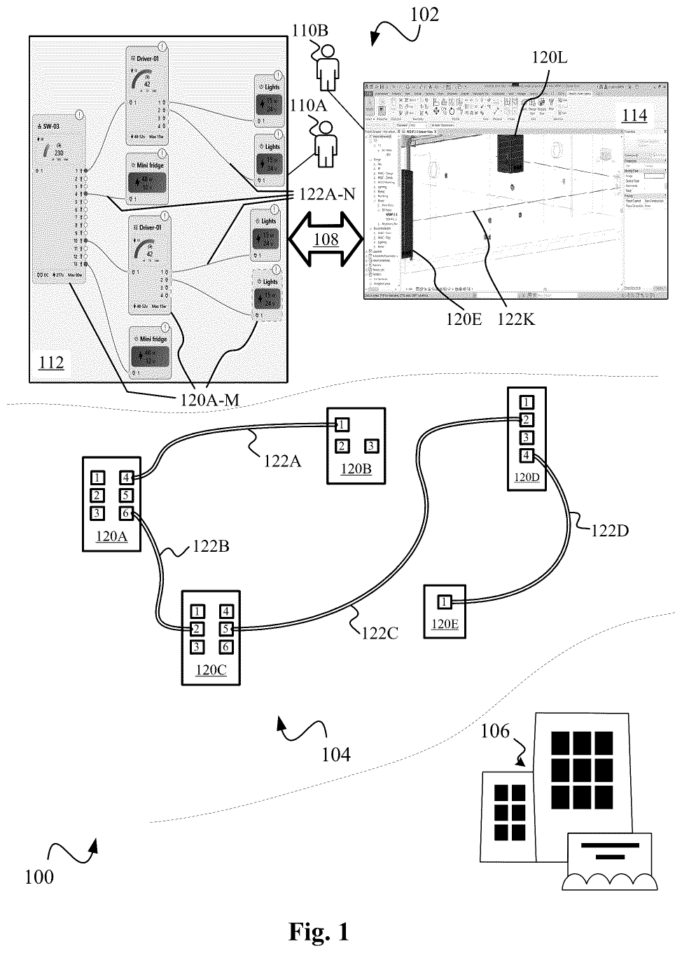

The systems and methods for low-voltage system design and modeling or simply low-voltage design or modeling based on the present disclosure will be best understood by taking advantage of FIG. 1. FIG. 1 shows an environment 100 comprising a low-voltage system or network 104 that is being designed to be deployed in a building 106. The design and modeling of low-voltage system/network 104 is innovatively facilitated by a low-voltage design system 102 of the present technology as will be described herein. The term low-voltage in the present disclosure subsumes the industry accepted definitions of low-voltage (LV) systems as well as extremely low voltage (ELV) systems. Thus, the scope of the present technology includes LV and ELV systems as known in the art, and we use the term low-voltage system/network to refer to either or both of them or any other low-voltage system.

According to the chief aspects, a user 110A of low-voltage design system 102 in interaction with system 102 first creates a schematic diagram or a network diagram or a network model or a schematic 112 of low-voltage system/network 104. Another user 110B, who may be referred to as the modeler, creates a corresponding three-dimensional (3D) design model or BIM model 114 of low-voltage system 104. Based on the instant principles, the effectiveness of 3D modeling for user 110B is greatly improved by incorporating or integrating schematic diagram 112 created by designer 110A into 3D model 114.

This integration between schematic diagram 112 and BIM model 114 is shown by block arrow 108 in FIG. 1 and affords a number of advantageous capabilities as will be explained in detail further below. In the preferred embodiment, the above integration of schematic 112 into model 114 is implemented by a file export/import mechanism. In such an embodiment, designer 110A first exports a schematic file of schematic 112 and then modeler 110B imports the schematic file into 3D model 114. In other embodiments, this integration may be real-time and may be based on other known techniques including application programming interface (API) calls.

In various embodiments, designer 110A and modeler 110B may be the same user or person. For this and reasons of brevity, we may refer to user 110 of instant low-voltage design system 102 in the singular form. User 110 incorporates various devices 120A-M in schematic diagram 112 and 3D model or BIM model 114 that will be comprised in low-voltage system 104. Any number of such device 120 may be present. In schematic diagram 112 of FIG. 1, only a subset of these devices 120 are marked using lead lines for clarity. Similarly, in the view shown of 3D model 114 of FIG. 1, only two such devices 120E and 120L are explicitly marked as shown.

While interactively creating schematic diagram 112 and 3D model 114 of our low-voltage system, user 110 also interactively creates the requisite connections 122A-N between the various devices. Any number of such connections 122 may be present. In schematic diagram 112 of FIG. 1, only a subset of these connections 122A-N are marked using lead lines to avoid clutter. Similarly, in the view of 3D model 114 shown in FIG. 1, only one such connection 122K is marked as shown.

The physical representation/rendition or counterpart of schematic diagram 112 and 3D BIM model or simply BIM model 114 is illustrated by low-voltage system 104 in environment 100. In other words, it is the physical low-voltage system 104 with physical devices 120 and physical connections 122 that is currently or prospectively deployed in building 106. Physical system 104 is being designed by user 110 using instant low-voltage design system 102 and with the aid of schematic diagram 112 and 3D model 114. Only a subset of devices 120 i.e. devices 120A-E and only a subset of connections 122 i.e. connections 122A-D are shown and marked in the physical counterpart 104 of schematic diagram 112 and 3D model 114 in order to avoid clutter.

Devices 120 may include low-voltage power supplies, Power over Ethernet (PoE) network switches or simply PoE switches, low-voltage drivers or simply drivers or endpoint devices such as low-voltage lighting equipment, PoE injectors, Fault Managed Power (FMP) devices, among others. Connections 122 may be physically formed by using a variety of different cable-types including Category (CAT)-5, CAT-6, American Wire Gauge (AWG)-14, AWG-12, Fiber optic cables, among many others.

Schematic diagram 112 and 3D model 114 are integrated with each other based on the instant principles and as shown by block arrow 108 in FIG. 1. The mechanics of implementing this integration were discussed above. However, let us now review in detail what we mean by integration 108 from the perspective of the internal interrelationships between various elements of schematic 112 and model 114. What integration 108 signifies is that 3D model 114 is fully aware of the choices of devices 120 and connections 122 made in schematic diagram 112 by user 110.

Explained further, user 110 can associate each element of schematic diagram 112, such as a device 120 or a connection 122 to its respective 3D model or simply 3D counterpart in 3D model 114. In accordance with instant integration 108 between schematic 112 and 3D/BIM model 114, each of devices 120 in schematic 112 are associated with their corresponding 3D counterpart devices in 3D model 114. Similarly, each of connections 122 in schematic 112 are associated with their corresponding 3D counterpart connections in 3D model 114.

As will be explained further, until such an association is made by user 110, an alert is shown for the user. Exemplarily, such an alert is shown by an exclamation mark (!) on the un-associated element in schematic diagram 112. Of course, the devices and connections in schematic diagram 112 and 3D model 114 have their physical counterparts in physical low-voltage network 104 and which is actually realized or deployed or installed in building 106.

At the outset, user 110 creates schematic diagram 112 for physical network 104. For this purpose, the user makes/creates a connection in schematic diagram 112 between a first device and a second device as follows. User 110 selects the exact port, which may be referred to as an output port or a first port, from a set of ports on the first device, and the exact port, which may be referred to as an input port or the second port, from a set of ports on the second device. It is between this output or first port of the first device and the input or second port of the second device that the connection is made.

The above aspect of the present technology is made even clearer if we now refer to physical low-voltage system 104 in FIG. 1. In system 104, connection 122A is made between output/first port #4 of multiport device 120A and input/second port #1 of multiport device 120B. Similarly, connection 122C is made between output or first port #5 of multiport device 120C and input or second port #2 of multiport device 120D. Of course, a device may only have a single port, such as device 120E shown in system 104 of FIG. 1.

In the above case, device 120E is an endpoint device with a single input port #1. In other words, the set of ports of device 120E has a size of 1 and consists only of port #1. Thus, connection 122D is made between output port #1 of device 120E and input port #4 of device 120D in FIG. 1. Using our current terminology, the former port is referred to as the first port and the latter port is referred to as the second port, and the connection is made between the first and the second ports.

The above selection of input/output ports of first/second devices for creating connections is made in schematic diagram 112. For this purpose, appropriate GUI affordances, including dropdown menus and drag-and-drop widgets, are provided in instant low-voltage design system 102. In the preferred embodiment, there is a schematic module of system 102 that is responsible for the creation and maintenance of schematic diagram 112. Because a schematic diagram may be considered as a network diagram, the schematic module may also sometimes be referred to as the network module.

In such an embodiment, the GUI for creating/updating the schematic is provided by this schematic module of system 102. User 110 also associates the desired cable-type for the cable for each connection in schematic diagram 112. For example, user 110 may associate cable-type CAT-5 for connection 122A, cable-type CAT-6 for connection 122B and so on. Again, appropriate GUI affordances including dropdown menus are provided for this purpose in low-voltage design system 102 and preferably in its schematic module.

Further in accordance with instant integration 108 between schematic model 112 and 3D model 114 of low-voltage design system 102, once user 110 has made the selection of ports for the connections between the devices in schematic diagram 112, system 102 can automatically identify in 3D model 114 the physical ports on the counterpart 3D devices that are utilized for those connections. In other words, for device 120A, which may be a PoE network switch, instant low-voltage design system 102 automatically connects a cable on its port #4 in 3D/BIM model 114. It does so based on the exact physical location of the port on the device.

Similarly, the system automatically connects the same cable on port #1 of device 120B in BIM model 114 based on the exact physical location of the port on that device. For the above to be accomplished, the system imports the specification or data sheets for the devices in its device library beforehand, so that it already knows the dimensions of the devices, the number and types of ports they have and where on the devices they are located. As will be discussed further below, this specification can be uploaded into the system or created by the user, as well as updated afterwards as needed.

System 102 also automatically selects the right cable-type for the cable in 3D-model 114. This is because the correct/desired cable-type was already associated to that connection in schematic diagram 112 by user 110. As low-voltage systems can have a variety of cable-types including CAT-5, CAT-6, AWG-14, AWG-12, Fiber optic cables, among many others, using the correct 3D representation for the cable-type for each connection in low-voltage design is a major benefit of the present technology over prior art techniques. Similarly, having an accurate representation of the actual physical ports on each device that are used for various low-voltage connections provides a major advantage in low-voltage design as compared to techniques of the prior art.

As another innovative aspect of the present technology, the system calculates how much reduction or drop in voltage or voltage-drop will occur for each connection based on the length and cable-type/type of the cable installed or deployed for the connection. Explained further, the present design computes the voltage-drop for each connection using the following equation:

$${V}_{drop} = 2 * I * R * L \qquad Eq . ( 1 )$$

where, V_{drop}=value of voltage-drop, I=value of current carried by the connection, R=value of resistance (or impedance) per 1,000 feet of the cable or conductor as determined by wire/cable AWG and L=one-way length in feet of the cable divided by 1,000.

Exemplarily, a fire-alarm system can typically tolerate a voltage-drop of 5% for a deployment. Therefore, if low-voltage system 104 of FIG. 1 is a fire-alarm system, and the voltage-drop for any connection computed by deploying Eq. (1) exceeds 5%, an alert is raised for user 110.

The user can then take corrective action by adjusting the parameters of the low-voltage design such that expected voltage-drop for the connection stays below the acceptable value of 5%. Exemplarily, user 110 may select a different cable-type for the connection, such as by using a lower gauge wire e.g. from AWG-14 to AWG-12 wire to address or alleviate or compensate for the above voltage-drop. In addition, or alternatively, the user may alleviate or resolve the voltage-drop by reducing the distance in 3D-model 114 between the respective devices of the connection. Still, additionally or alternatively, user 110 may alleviate or address the voltage-drop by selecting a different device or devices for the connection such that the expected voltage-drop is acceptable.

As yet another innovative aspect of the present technology, once user 110 has created schematic diagram 112 and 3D BIM model 114, an electrical load analysis is automatically performed for low-voltage system 104 being designed. The purpose of electrical load analysis or simply load analysis is to identify overload conditions for any devices in schematic 112. These overload conditions are of two types:
(i) When potential load on a device is expected to exceed its rated maximum based on the existing devices and connections to it in schematic 112.
(ii) When potential load on a device is expected to exceed its rated maximum if all of its downstream devices are connected and fully loaded.

If the potential load on a device already exceeds the maximum rated load value for that device as per the existing design in/of schematic 112, then this condition is referred to as overload condition (i). If all downstream devices for a given device are connected and are loaded to their maximum load values, then this is referred to as overload condition (ii).

In the preferred embodiment, alerts for the above overload conditions are raised by showing appropriate alert symbols on schematic diagram 112. Exemplarily, potential load alert for overload condition (i) is shown in schematic 112 by a dial widget in red on the device in the GUI. If the potential load value is comfortably below the rated maximum value/capacity/threshold, the dial is shown in green. As the potential load value moves towards the rated maximum, the dial changes its color to orange-green, then orange, orange-red, and then red. Similarly, overload condition (ii) is shown by an appropriate warning symbol on the device in question in schematic 112.

Thus, at the very outset, and while designing low-voltage system 104, user 110 can ensure that the potential or expected load values on the devices stay at safe operational levels. If a potential/expected load value reaches or exceeds rated maximum or threshold, the user can alter the design, such as by using a different device or reducing the number of connections, choosing different downstream devices that have lower load consumption, among others.

The low-voltage design systems and methods of the present principles may be implemented as a standalone system or as a plugin or an add-in to/into another computer-aided design (CAD) system, such as Autodesk's Revit® CAD system. Thus, the instant technology provides advanced design, modeling, and visualization features tailored explicitly to low-voltage system installations, such as FMP and PoE system installations. Whether implemented as a standalone system, or as a plugin/add-in to an existing CAD system, the distinguishing aspects of the present technology include:
1. Unified Design Environment (UDE): Instant system or plugin provides a unified workspace dedicated to the design and modeling of low-voltage systems/infrastructure. This workspace allows users to seamlessly incorporate low-voltage devices, cables, switches, and other relevant components into their building designs.
2. Comprehensive Device/Component Library: The system/plugin offers an extensive device library of low-voltage components, including FMP and PoE components, ranging from FMP and PoE-powered devices to PoE switches and injectors. Users can select components based on various factors including power requirements, data bandwidth, and device compatibility, ensuring an accurate representation of the low-voltage network.
3. Accurate Cable Path Simulation: Users can simulate the routing of Ethernet cables carrying both power and data within the BIM model. The plugin accurately visualizes cable paths, lengths, and connections, enabling designers to foresee potential challenges and optimize cable layouts.
4. Voltage and Power Management: The instant low-voltage design system includes tools to manage voltage levels and power consumption throughout the FMP and PoE networks. Users can assess power budgets, voltage drop scenarios, and device compatibility to ensure reliable and efficient power delivery.
5. Realistic Visual Representation: The system generates realistic visual representations of low-voltage devices, cables, and components within the BIM model. This facilitates clear communication between designers, stakeholders, and contractors, ensuring a common understanding of the intended FMP and PoE infrastructure.
6. System Performance Analysis: Users can analyze the performance of the designed low-voltage networks using instant simulation capabilities. It provides insights into data transfer rates, latency, and potential network congestion, aiding in optimizing system performance.
7. Documentation and Reporting: The system generates comprehensive reports documenting the FMP and PoE design, including component lists, cable configurations, power budgets, and other critical information. This documentation streamlines the communication of design intent to implementation teams.
8. Collaboration and Interoperability: The present design promotes collaboration among project stakeholders by allowing the exchange of design data between the present system and external network management tools. This ensures a seamless transition from design to implementation.
9. Bidirectional checks: A key innovation of the present design is complete integration of the schematic diagram or network schematics and the corresponding 3D model or BIM model. This instant capability is also referred to as bidirectional checking between the network schematics and the modeling elements or the instant ability to “marry” the schematics with the BIM model. As will be discussed further below, in the preferred embodiment, this capability is implemented by displaying an exclamation mark (!) on those devices in the schematic diagram that have not yet been associated with an element of the BIM model.
Once the corresponding element has been associated, the exclamation mark is removed, and the user can locate the associated element on the 3D model by selecting the device on the schematic diagram and clicking the magnifying glass icon in the top left corner of the instant schematic module.
10. Load calculation and warnings: Another key innovation of the present technology is load calculation or analysis. Once a device is detected/determined to be overloaded under an overload condition, such as overload conditions (i) and (ii) discussed above, an appropriate alert is raised for the user.

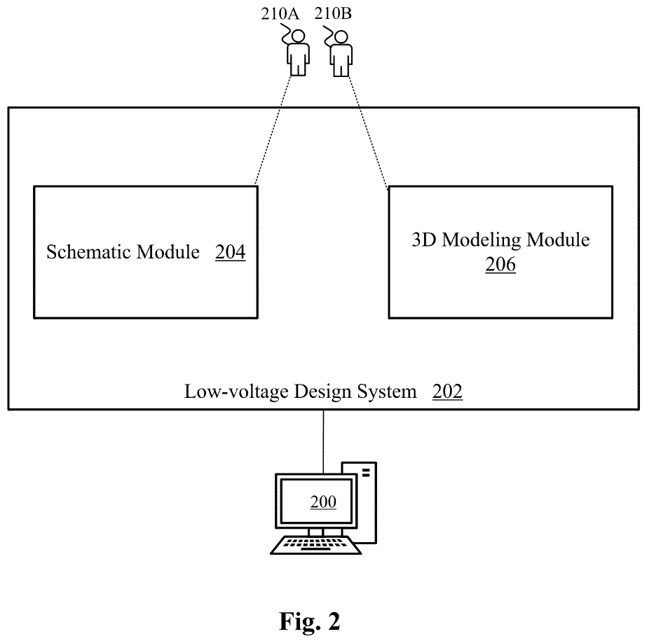

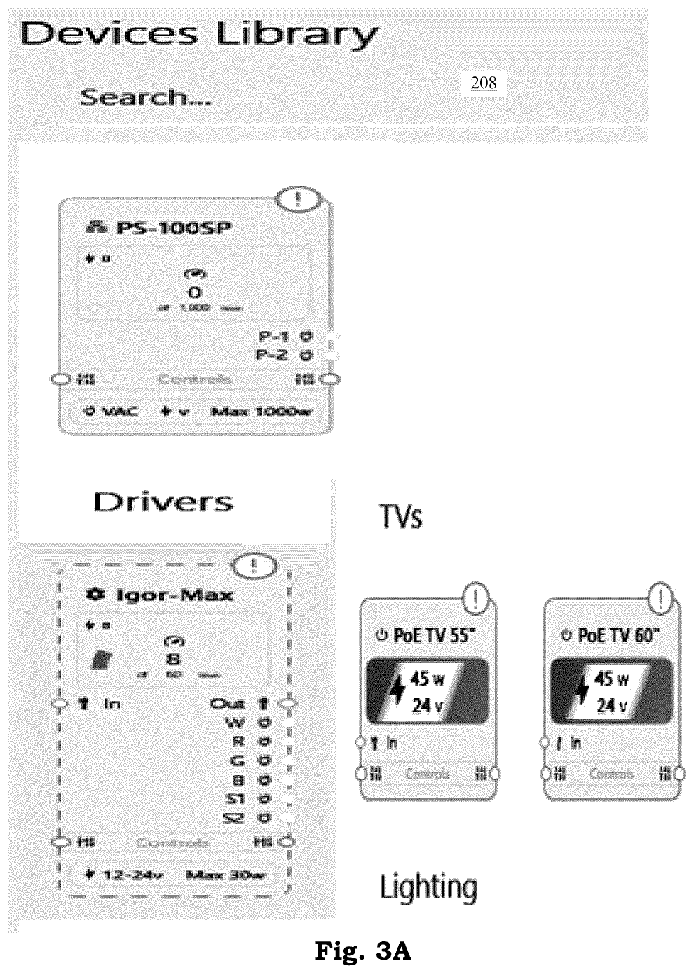

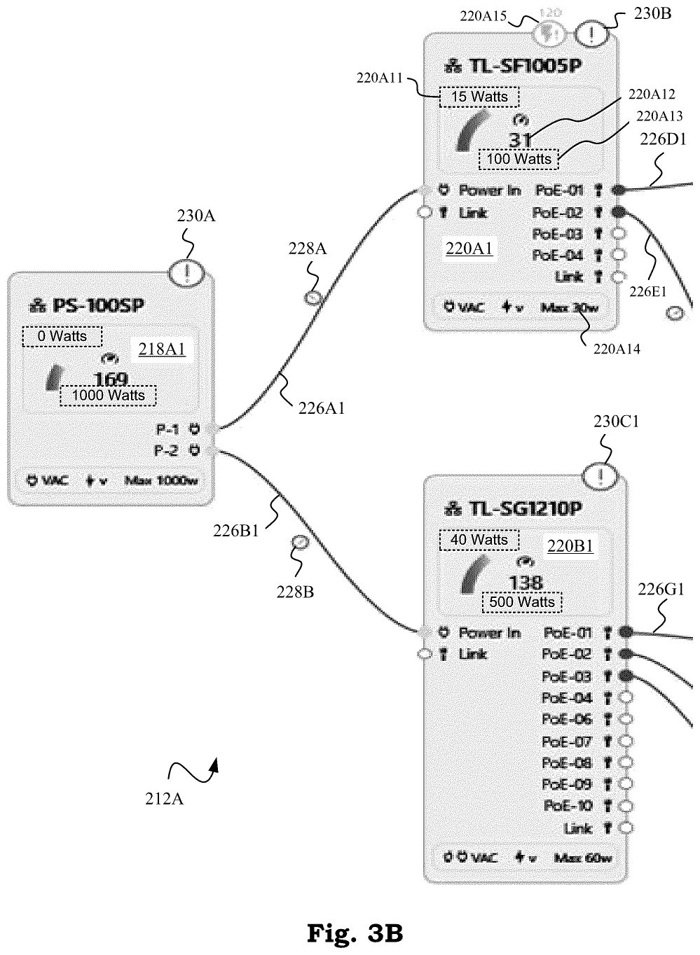

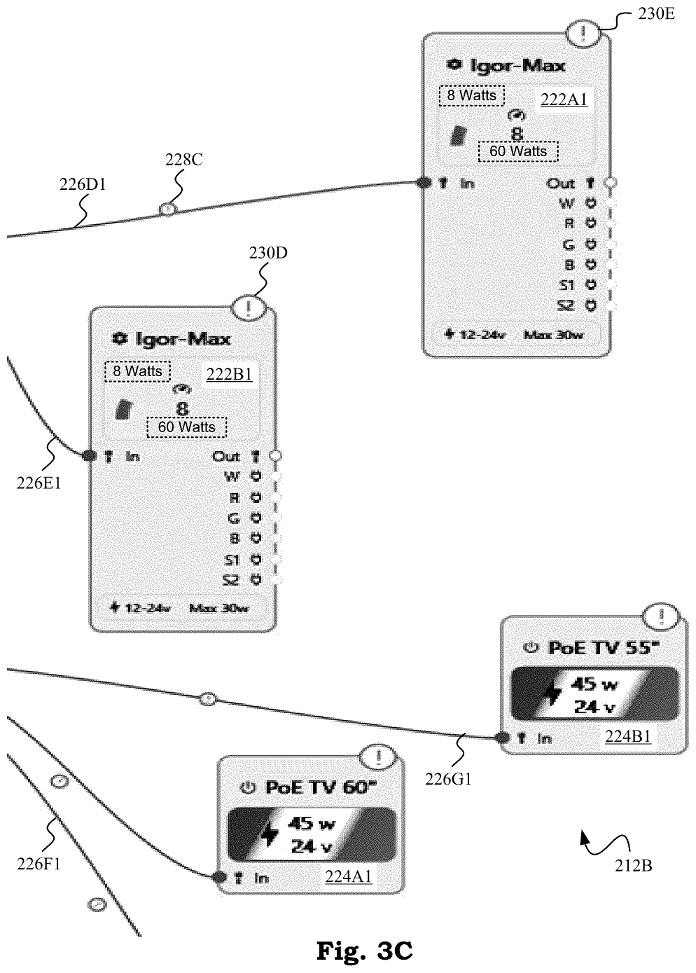

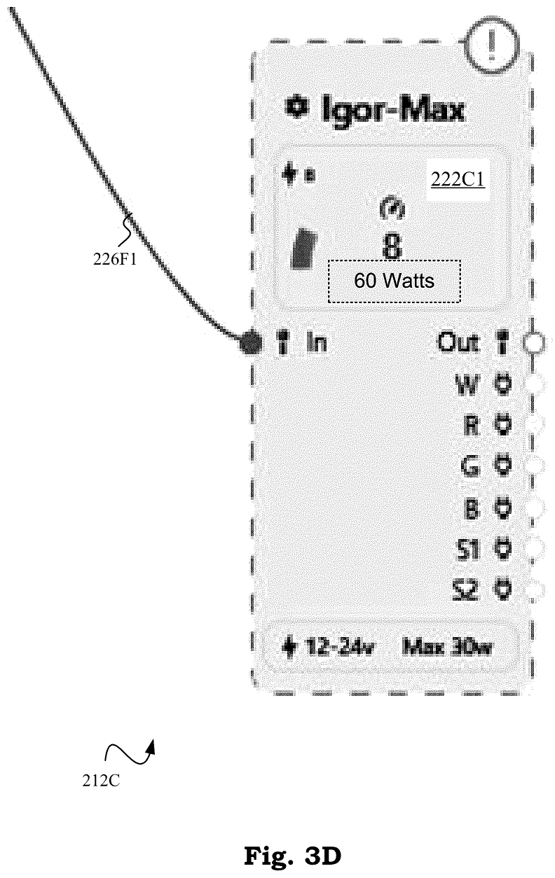

Let us now review the workings of the present technology in even more detail. For this purpose, let us review FIG. 2 in conjunction with FIG. 3. FIG. 2 shows an overall block diagram of an instant low-voltage design system 202 operating on a computer system 200. Computer system 200 has the requisite hardware and software components for executing the computer instructions of instant low-voltage design system 202. As shown, low-voltage design system 202 comprises two key modules, one is a schematic module 204 that is responsible for the design and maintenance of the schematic diagram. The other is a 3D modeler or a 3D modeling module or simply a 3D module 206 that is responsible for the creation and maintenance of the 3D BIM model corresponding to and integrated with the schematic diagram.

User 210A, typically referred to as a designer, is responsible for using schematic module 204 for creating/updating the schematic diagram. User 210B, typically referred to as a modeler, is responsible for using 3D modeling module 206 for creating/updated the BIM model. As in other embodiments, designer 210A and modeler 210B may be the same user or person. For this and reasons of brevity, we will generally refer to user 210 of instant low-voltage design system 202 in the singular form, making distinction where necessary.

User 210 e.g. designer 210A first creates the schematic diagram of a current or a prospective low-voltage system/network to be deployed or installed or realized in a building or site. For this purpose, the user 210 uses schematic module 204 of system 202. FIG. 3 shows sections of a screenshot taken while using schematic module 204 for creating an exemplary schematic diagram 212. More specifically, FIG. 3A shows a screenshot portion or section showing a device library 208 from which the user can select the devices to be added or included in schematic diagram 212 of FIG. 3. Any number of low-voltage devices including power supplies, switches, drivers, injectors, TVs, lighting equipment, etc. may exist in the device library that the user may adopt into the schematic diagram being created.

The power supplies here refer to power supplies that are used to provide power as output to a low-voltage system/network by drawing power as input from one of a higher-voltage power sources, including 120V, 240V, 480V or higher. Shown in device library 208 are a Power over Ethernet (PoE) power supply labeled PS-100SP, a PoE driver labeled Igor-Max, an endpoint device or PoE TV of screen-size 55 inches (or 55″), and an endpoint device PoE TV of screen-size 60 inches (or 60″).

FIG. 3B presents a section of the same screenshot of schematic diagram 212 that is being created. More specifically, FIG. 3B shows a section 212A of overall schematic diagram 212 that now contains the various devices that the user has selected to be included in it from device library 208 above. Schematic diagram portion 212A is shown to contain power supply 218A1, PoE switches 220A1 and 220B1 as shown. Also shown is connection 226A from an output port or first port of power supply 218A1 to an input port or a second port of PoE switch 220A1. There is also a connection from an output port of power supply 218A1 to an input port of PoE switch 220B1 as shown. Similarly, other connections 226 are marked as shown, and not all connections have been explicitly marked to avoid clutter.

FIG. 3C shows a subsequent section 212B of schematic diagram 212 with the various devices and connections originating from section 212A of FIG. 3B. More specifically, schematic diagram section 212B of FIG. 3C shows drivers 222A1, 222B1 and endpoint devices 224A1, 224B1 which are PoE TV 55″ and PoE TV 60″ respectively chosen from device library 208 above. FIG. 3D shows a schematic section 212C of schematic diagram 212 with a driver 222C1 and connection 226F1 originating from section 212B of FIG. 3C.

Device 222C1 is shown with a dashed line around it. In fact, the dashed line is shown rotating or moving around device 222C1 in the GUI. This means that the user has selected it, likely with the intention of changing/updating its properties or attributes, including, port configuration, power rating among others, and as will be discussed further below. In general, if any of the element on schematic diagram 212 is shown on the GUI with a moving dashed line, this means that the element is under selection by the user such that its properties/attributes may be changed/updated. Preferably, the element is selected per above, by “right-clicking” on the element and selecting it on the GUI.

In FIG. 3, when an exclamation mark (!) symbol in a circle appears on an element in schematic diagram 212, it represents that the element has not been associated with a counterpart 3D element on the 3D/BIM model yet. For example, alert icon or exclamation symbol 230A on power supply 218A1 means that power supply 218A1 on schematic 212 has not yet been associated to a power supply element on the corresponding 3D/BIM model. Similarly, alert icon 230B on driver 220A1 means that driver 220A1 on schematic 212 has not yet been associated to an element on the 3D/BIM model. Once an association between a device on the schematic diagram and a corresponding 3D device on the 3D model has been made, the respective alert icon or exclamation mark symbol 230 goes away. Appropriate GUI affordances via GUI widgets including dropdown menus and selection/check boxes are provided to user 210 for making the above associations.

In an analogous manner to alert icons 230, alert icons 228 on connections 226 represent that respective connections have not been associated to respective 3D cable connections or cable routings or cablings on the BIM model yet. For example, alert icon 228A on connection 226A1 means that connection 226A1 on schematic 212 has not yet been associated to a specific 3D cable connection on the 3D/BIM model. Similarly, exclamation symbol 228B on connection 226B1 means that connection 226B1 on schematic 212 has not yet been associated to specific 3D connection on the 3D/BIM model. Once an association between a connection on the schematic diagram and corresponding 3D connection or cable on the 3D model has been made, the respective alert icon symbol 228 disappears. Appropriate GUI affordances with GUI widgets including dropdown menus and selection/check boxes are provided to the user for making the above associations.

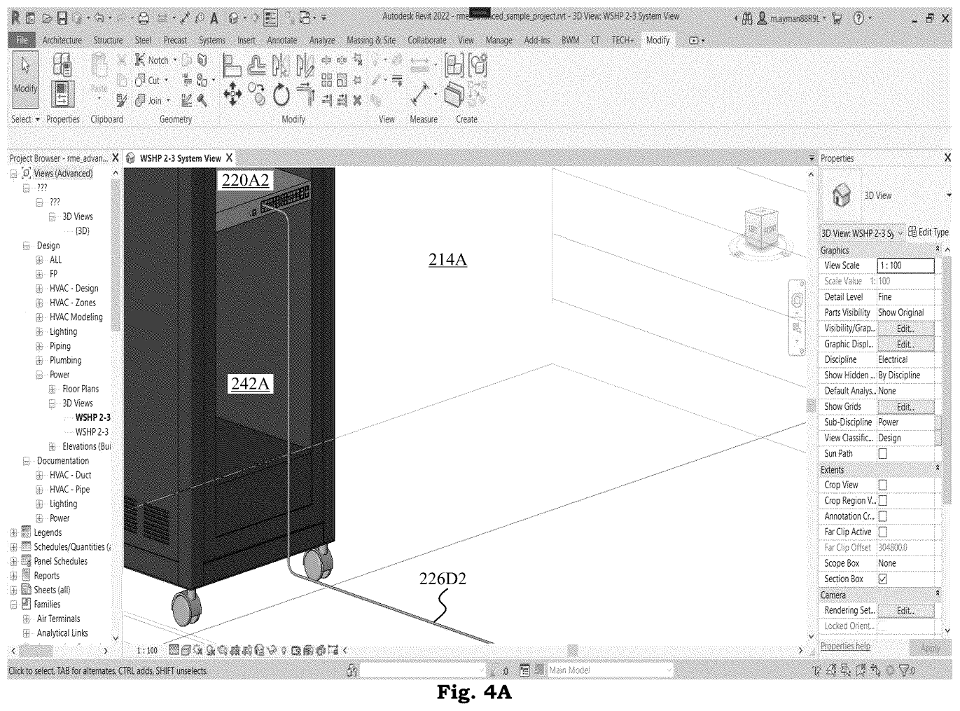

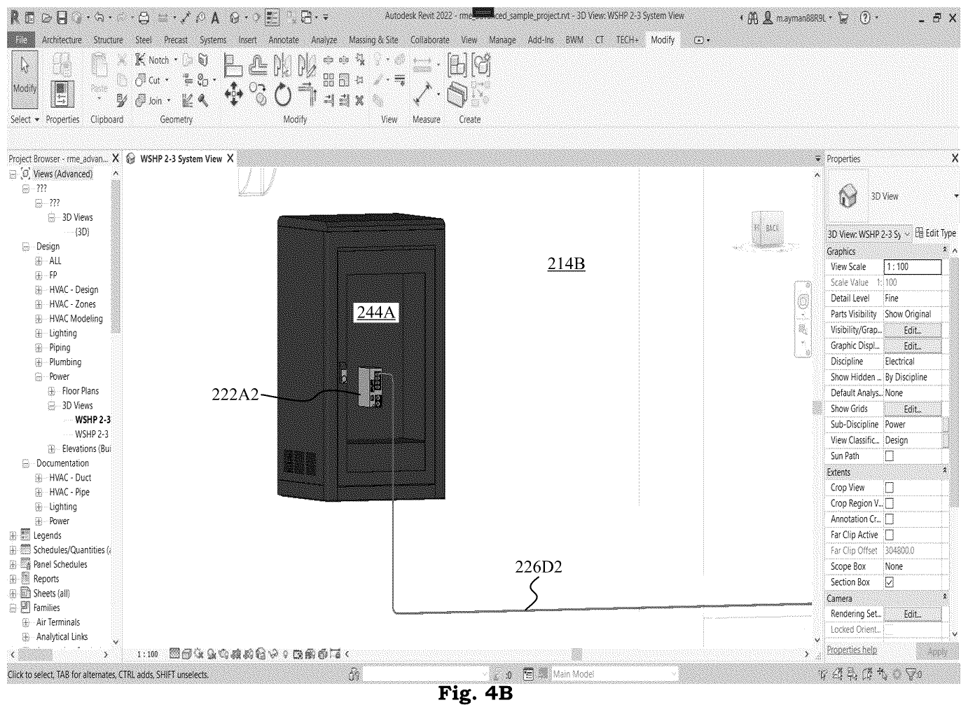

FIG. 4 in conjunction with FIG. 2-3 shows sections of BIM/3D model 214 corresponding to schematic 212 of FIG. 3. BIM Model 214 is created by user 210 e.g. modeler user 210B by using 3D module 206 of low-voltage design system 202 of FIG. 2. More specifically, FIG. 4A shows a 3D switch 220A2 that has been associated to its counterpart switch 220A1 in schematic 212 of FIG. 3. In section 214A of instant BIM/3D model of FIG. 4A, switch 220A2 is shown mounted on a rack 242A. Also shown in FIG. 4A is cable 226D2 with a CAT-5 cable-type extending from a specific port of switch 220A2. This 3D cable connection or simply cable 226D2 on BIM model 214 is the counterpart or associated connection of connection 226D1 on schematic 212 of FIG. 3. Eventually, connections 226D of FIG. 2-3 are realized by installing or deploying a CAT-5 cable between the respective devices in a physical site or building, such as building 106 shown in FIG. 1.

FIG. 4B shows a subsequent section 214B of section 214A of BIM model 214 shown in FIG. 4A. More specifically, FIG. 4B shows driver 222A2 that is the counterpart/associated 3D driver in BIM model 214 of driver 222A1 of schematic 212 above. Also shown in FIG. 4B is cable 226D2 extending from FIG. 4A to a specific port of device 222A2. Driver/device 222A2 is mounted on rack 244A in the 3D illustration of FIG. 4B. Per above explanation, since devices 220A1/222A1 of schematic 212 have thus been associated to counterpart devices 220A2/222A2 of BIM model 214 as shown in FIG. 4, the respective alert icons 230B and 230E on schematic 212 would disappear. Similarly, since a specific cable connection or cabling 226D2 has now been associated to respective connection 226D1 of schematic 212 of FIG. 3, corresponding exclamation mark symbol 228C on connection 226D1 in FIG. 3 would disappear.

These associations between the elements of schematic diagram 212 and 3D model 214 are a key distinguishing aspect of the present design. These are enabled by a deep integration between the design and modeling aspects of low-voltage design as afforded by the instant technology. Also, as a result of the above associations/integration, the specific port of switch 220A1 selected for connection 226D1 on schematic 212 of FIG. 3, is automatically identified and selected for cabling 226D2 for 3D device 220A2 on 3D/BIM model 214 of FIG. 4. This automatic identification of physical ports on devices in the 3D model based on port selections of their counterpart devices made on the schematic is another innovative aspect of the present design.

The user can associate a specific cable-type e.g. CAT-5 for a connection e.g. connection 226D1 on schematic diagram 212. This association of the specific cable-type on the schematic diagram causes 3D model 214 to automatically select a CAT-5 cable in the 3D routing of the cable in 3D model 214 as shown in FIG. 4. The routing thus accommodates all the physical characteristics of the cable in the 3D model. This automatic selection of cable-type in the 3D model based on the cable-type association on the schematic diagram is another advantage of the present technology over prevailing techniques.

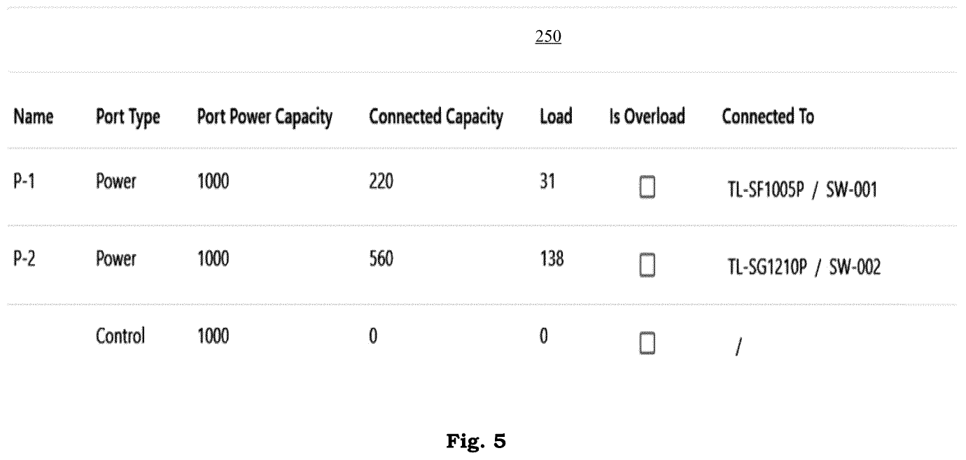

FIG. 5 shows a power data table 250 that is available to user 210 via schematic module 204 of instant low-voltage design system 202 of FIG. 2. More specifically, table 250 shows the various power attributes for device 218A1 or power supply PS-100SP on network schematic 212 of FIG. 3. As shown in table 250, the device is not under in any overload condition as none of the checkboxes in “Is Overload” column is checked.

In one embodiment, cable routings in the 3D model for forming the respective connections in the schematic diagram, are done or drawn manually by the user in the 3D model of an instant low-voltage design system, such as system 202 of FIG. 2. In an alternative embodiment, the routings are done automatically i.e. auto-routing is performed. In either case, based on the above-taught integration or “marriage” between an instant schematic diagram, such as schematic 212 of FIG. 3, and an instant 3D BIM model, such as BIM model 214 of FIG. 4, the correct ports on the devices between which a cable is to be routed are first identified by 3D module 206. The 3D modeler module also automatically selects the specific cable on BIM model 214 based on the cable-type associated with the respective connection on schematic diagram 212.

In the case of the manual routing embodiment, the user manually draws the cable from the output port of the first device to the input port of the second device on the 3D model. To facilitate this process guidelines are provided on the 3D model by 3D modeler 206 that aid the user in drawing the cable on a viable 3D path in the 3D model. In the case of the auto-routing embodiment, the cable is drawn automatically along a designated path between the identified input and output ports to form the connection. This greatly, facilitates 3D modeling of the low-voltage system based on the present technology.

Once the routings for the cables for forming respective connections has been done per above, the length and type of the cable for the connections is now known in the 3D model. At this stage, 3D modeler 206 of instant low-voltage design system 202 computes the reduction or drop in voltage that would occur for each connection by employing Eq. (1) above. If the potential voltage-drop in a connection is below an acceptable level or threshold or percentage, an alert is raised for the user in the 3D model. The acceptable voltage-drop is configured by user 210 into the system via an appropriate configuration screen/pop-up, preferably on the 3D-model. Such an acceptable threshold/percentage may be for the entire low-voltage network/system or for an individual connection.

In the case of Fire-alarm systems for instance, the acceptable drop in voltage from the driver to an endpoint device is 5%. This threshold may be configured for the entire low-voltage fire-alarm system. Now, if 3D module 206 determines that any connection in the 3D model would undergo a voltage-drop that is greater than 5% based on the above equation, an alert is raised for the user by 3D modeler 206 on 3D model 214. In the preferred embodiment, the alert is raised for the user via on appropriate pop-up screen/widget on the GUI.

If the above were to happen, the user can take appropriate corrective actions. Such corrective actions include adjusting/modifying schematic diagram 212 and/or 3D model 214. For instance, user 210 can associate a lower-gauge wire for the connection that is triggering the alert. As another example, let us assume that 3D connection associated to connection 226G1 on schematic 212 is triggering a low-voltage alert for user 210 e.g. modeler user 210B. Let us assume that the acceptable voltage-drop for device 224B1 i.e. PoE TV 55″ is 10% from driver 220B1.

Now let us assume that the cable-type associated with connection 226G1 on schematic diagram 212 is AWG-14, and the voltage-drop is 12% which is unacceptably high for TV 224B1. Now, based on the above voltage-drop alert, user 210 e.g. designer user 210A can associate a lower voltage cable-type/wire such as AWG-12 for connection 226G1. This modification can thus alleviate or address the voltage-drop by reducing it to below 10% and thus resolving the alert/issue.

Instead or in addition, modeler user 210B can also change the placement of PoE TV 55″ in BIM model 214 such that the distance or length of the wire is reduced. Still alternatively or in addition, user 210 can replace PoE TV 55″ with another device that is more tolerant of the voltage-drop. In this manner, the ability to proactively adjust the low-voltage in order to circumvent issues that may arise before the low-voltage system is realized or installed into a site/building, is a key innovation of the present technology.

Per above teachings, low-voltage design system 202 also detects potential overload conditions in schematic diagram 212. More specifically, schematic module 204 detects overload conditions (i) and (ii) and raises appropriate alerts for user 210 that can be proactively addressed. Referring to schematic 212 of FIG. 3, each device that is not an endpoint device is shown with 3 power ratings. These are shown for each such device but only explicitly marked for device 220A1 to avoid clutter. More specifically, device 220A1 has an intrinsic power rating of 15 Watts (W) shown in the dotted-line box in its upper left-hand corner identified by reference numeral 220A11.

Device 220A1 also has an existing power load of 31 W identified in its center by reference numeral 220A12. Device 220A11 has a maximum power rating of 100 W shown in a dotted-line box below the center and identified by reference numeral 220A13. Each of the output ports of device 220A1 i.e. ports PoE-01, PoE-02, PoE-03, PoE-04 can have a maximum load of 30 W, as identified by reference numeral 220A14 in the lower right-hand corner of device 220A1.

The intrinsic and maximum power ratings of each device as well as maximum load ratings for its ports are preloaded into the system before operation commences. Explained further, as a part of an initial population or preloading of its device/component library 208, the specification datasheets and any requisite configuration information for each device that is to be contained in device library 208 is loaded into system 202 of FIG. 2. From then onwards, device library 208 becomes aware of the electrical characteristics of every element in the library as may be needed by schematic module 204.

The device/component library also becomes aware of the physical characteristics of each element in the library as may be needed by 3D modeling module 206. Furthermore, the user can also create/add a device or update/modify the specifications, including port configurations and load ratings, for an existing device by selecting and updating it. So, if a certain device could not be preloaded into device library 208, or if the specs of a preloaded device need to be updated, user 210 can create/update it as needed.

Now, as shown in FIG. 3B, device 220A1 is not under overload condition (i) but it is under overload condition (ii). This is because its existing load is 31 Watts which is calculated as follows: Intrinsic load of device 220A1 i.e. 15 W+existing load on device 222A1 on connection 226D1 i.e. 8 W+existing load on device 222B1 on connection 226E1 i.e. 8 W=31 W. Since 31 W is less than 100 W which is the rated maximum load value for device 220A1, it is not under overload condition (i). Note however, that the dial on the device is inching higher. It would thus have an orange color in the GUI.

However, device 220A1 is under overload condition (ii) because if each of its output ports PoE-01 through PoE-04 are under the maximum load rating of 30 W for the port, this would incur a load on the device of 30 W×4=120 W which is higher than its maximum rating of 100W. This overload condition (ii) is shown on device 220A1 by alert symbol 220A15 with the potential maximum load value of 120 W that would trigger such an alert. Thus, based on the present technology user 210 can be proactively alerted of a potential overload condition/situation that may arise once the low-voltage system/network being designed is realized/installed/deployed at building or site.

As a result, user 210, in particular designer user 210A, can take remedial actions to circumvent such a scenario by modifying schematic diagram 212 as necessary. At least the user can be aware of such issues that may arise later. For example, user 210 may replace device 220A1 with a higher rated device to circumvent overload condition (ii). They may also choose to deploy the system as designed while being cognizant of a potential overload condition (ii) that may arise during operation. Such a condition may be averted during the operation by ensuring that not all the ports of device 220A1 are maximally loaded and/or by only loading ports such that the maximum load on the device is at or below 100 W.

The ability of the present design to calculate future load conditions on a low-voltage network as well as to compute drop in the voltage levels to the endpoints is also referred to as its simulation capabilities. In effect, the present technology simulates the future operation of the system/network as it will be realized/installed while still being designed. This simulation capability is key contribution of the present technology to the field of low-voltage design.

Low-voltage systems or networks that may benefit from the present technology can be of several types. Thus, low-voltage design system 102/202 of FIG. 1/FIG. 2 can be used to design a PoE network, a fault managed power (FMP) system, a distributed antenna system (DAS), a closed-circuit television (CCTV) system, a fire-alarm system, a paging system, an audio-visual (A/V) system, a data network, a secure entry system, a physical intrusion detection system (IDS) among others.

In one preferred embodiment, low-voltage design system 102 of FIG. 1 or 202 of FIG. 2 is implemented as a standalone system. In another preferred embodiment, system 102/202 is implemented as an add-in or a plugin to an existing CAD system. Preferably, such a CAD system is Audodesk Rivet®. This is because of the widespread use of the Rivet platform. Other BIM systems that may benefit from such a plugin include Bentley Systems (AECOsim Building Designer, MicroStation), GRAPHISOFT Archicad, Nemetschek Allplan, Trimble Tekla Structures, Vectorworks Architect, Dassault Systemes CATIA, BricsCAD BIM, Rhino, and SketchUp®.

Another useful feature of the present low-voltage design systems is its ability to generate a bill of materials (BOM) on demand. In other words, user 210 of low-voltage system 202 can generate a BOM as needed by the click of a button in schematic module 204, 3D module 206 or elsewhere. Since system 202 already knows all the elements that are required for a low-voltage network, including the devices, cable-types and length of the connections, it is straightforward for the system to generate such a BOM. Recall from above, that the number and types of low-voltage devices are known by schematic module 204 and the length of cable connections and specific cable-types are known by 3D module 206 per above teachings.

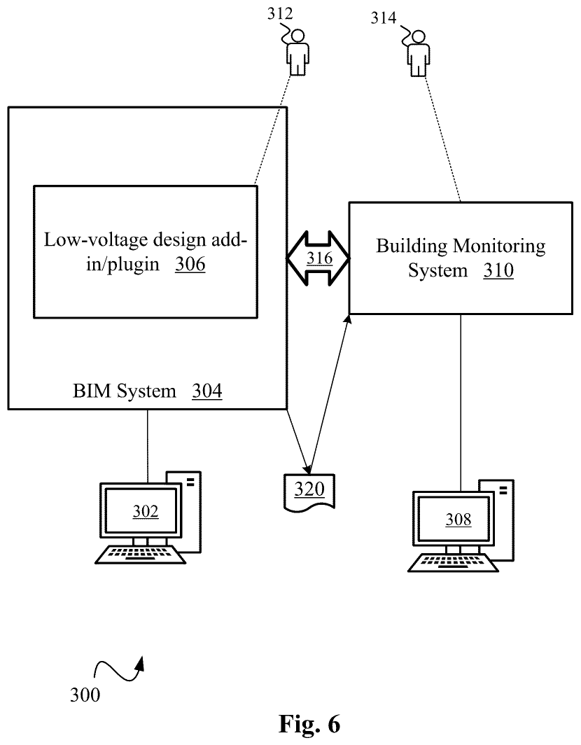

In yet another set of preferred embodiments of the present technology, the instant low-voltage system is integrated into/with a building monitoring system (BMS). Such an integrated embodiment 300 is shown in FIG. 6 where the instant technology is implemented as a low-voltage design add-in or plugin 306 to an existing BIM system 304 operating on a computer system 302 and operated by user 312. There is also a BMS 310 operating on a computer system 308 operated by user 314.

In accordance with BMS integration shown by block arrow 316 of the present embodiments, 3D model 320 of a low-voltage system is first created using low-voltage design plugin 306 and then imported to BMS 310 as depicted. Depending on the implementation, 3D/BIM model 320 may be exported out of system/plugin 306 via BIM system 304 first, and then imported to BMS 310. Alternative ways of uploading instant 3D model 320 to BMS 310 are conceivable based on known techniques. In the preferred embodiment, low-voltage design 3D model created using instant system/plugin 306 is part of the overall 3D model for a given site or building. Such an overall 3D model for a site/building is also referred to as a digital asset.

Thus, in such a preferred embodiment, it is digital asset 320 that is exported from BIM system 304 and within it is contained the low-voltage 3D model for the building/site created by user 312 using instant plugin 306. Digital asset 320 is then imported into BMS 310 per above. In addition, a list of addressable datapoints or datapoints or data links of the building are also imported to BMS 310. Such a list would be first exported on-site at the building from its control system. Once that is done, user 314 can thus map each low-voltage datapoint of the building in BMS 310 to its corresponding element in digital asset 320.

Exemplarily, user 314 maps endpoint devices 224A1, 224B1 of FIG. 3C into BMS. Let us now assume that BMS 310 detects an incident in one of the devices in the building i.e. at one of the datapoints imported in it. If this datapoint in BMS 310 was mapped, for instance, to device 224A1 in schematic 212 and 3D device 224A2 in 3D model 214 contained in digital asset 320, then user 314 instantly knows on BMS 310 the exact low-voltage device that was involved in the incident. BMS 310 can be one of the many BMS choices available in the industry including those from vendors such as Siemens™, Johnson Controls®, Schneider Electric™, Honeywell®, ABB™, Trane®, Delta Controls™, Crestron®, Distech Controls™, and Carrier®.

The techniques of the prior art cannot perform such an incident monitoring of low-voltage system, but rather only of higher voltage systems. Thus, the present technology fills a longstanding need by providing real-time or near real-time identification of incidents caused in/by low-voltage devices at various sites and deployments. It does so by providing instant visibility into such incidents via BMS 310 in accordance with integration 316 with instant low-voltage design system/plugin 306 per above discussion.

Once an incident or an issue or a fault with a low-voltage device or element is identified, then a maintenance worker can be dispatched to address the issue. The maintenance worker may replace the faulty device, such as by replacing PoE TV 60″ 224A1 in the above example of FIG. 3, and more specifically FIG. 3C. The worker may also first simply change the port of driver device 220B1 i.e. TL-SG1210P that is driving the TV. If it was a faulty port of the driver then this may just fix the fault without replacing the device.

In any case, once the fault has been resolved, user 314 can then adjust schematic diagram 212 and 3D model 214 of the low-voltage system to reflect the current status of the network. In other words, if the maintenance worker changed the faulty output port driving the implicated device, then schematic 212 and the 3D/BIM model 214 should be updated to reflect that. Similarly, if a device was replaced by another device that is not identical in specification to the replaced device, the schematic and the BIM model should be updated to reflect reality.

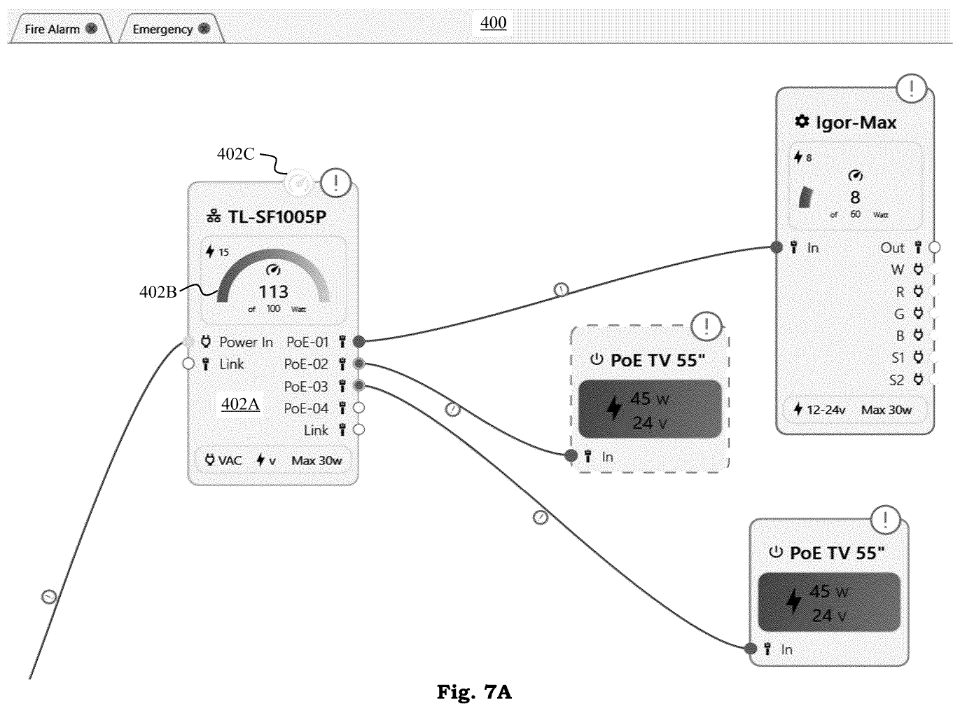

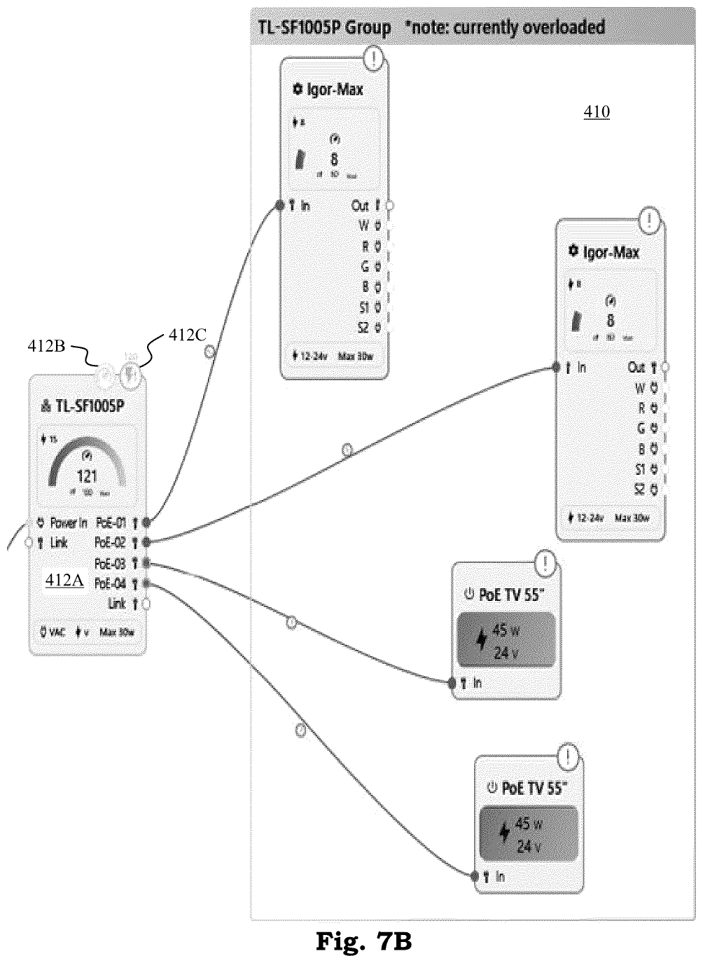

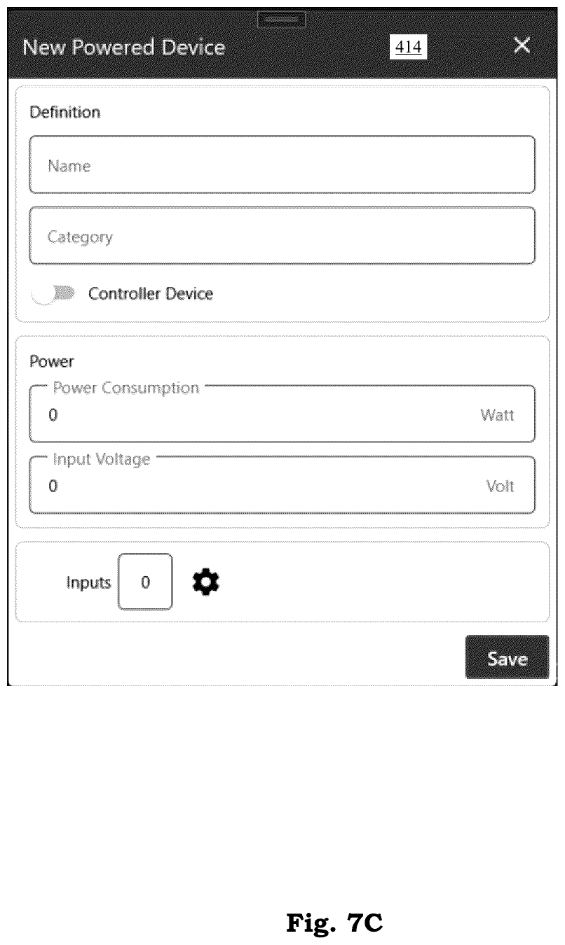

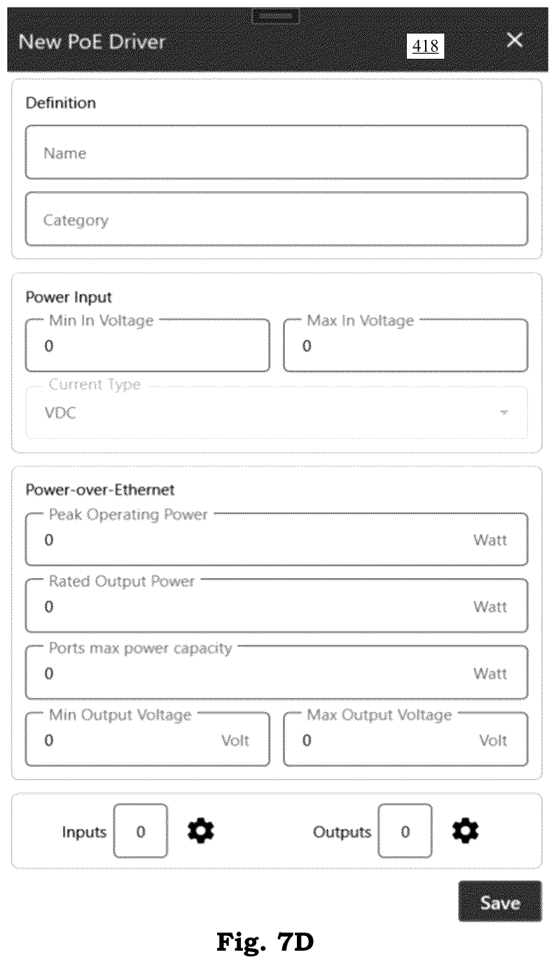

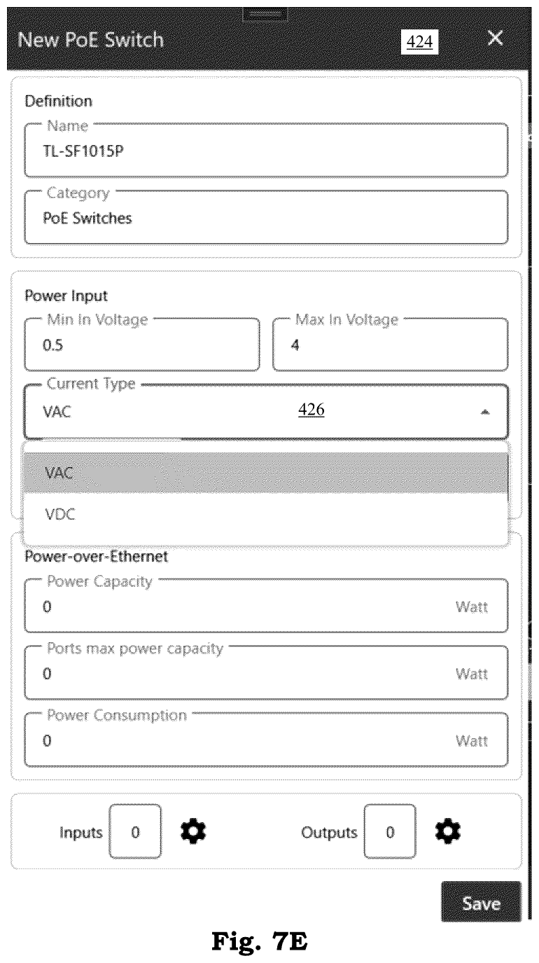

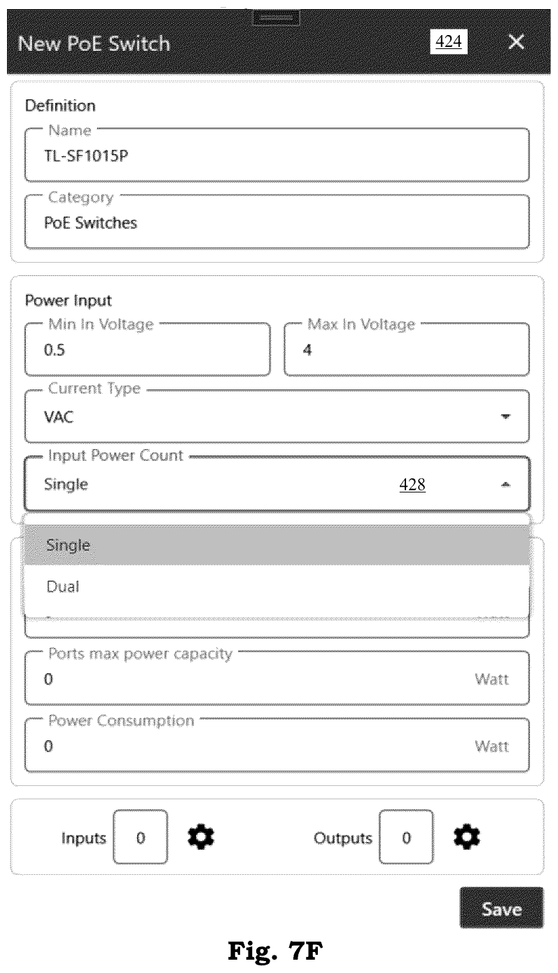

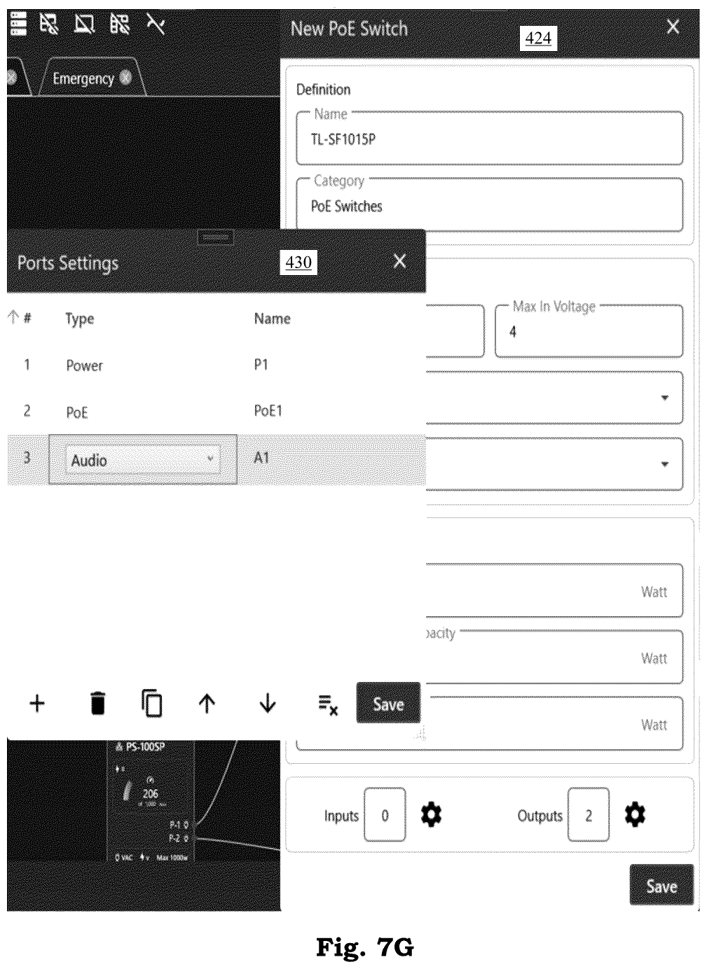

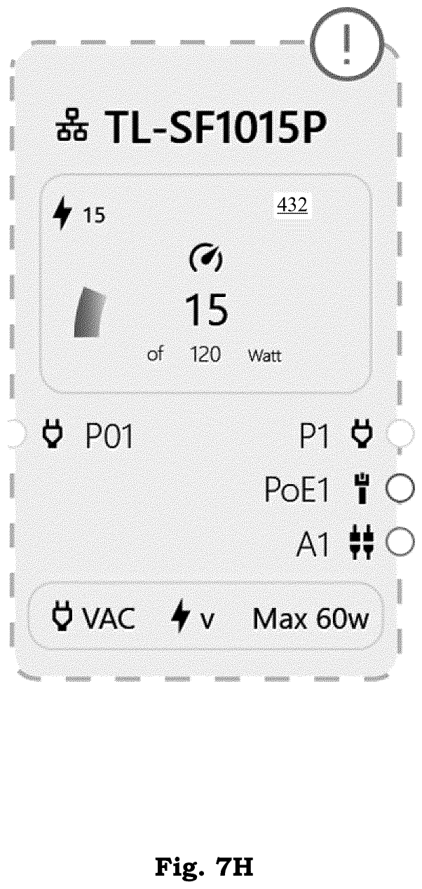

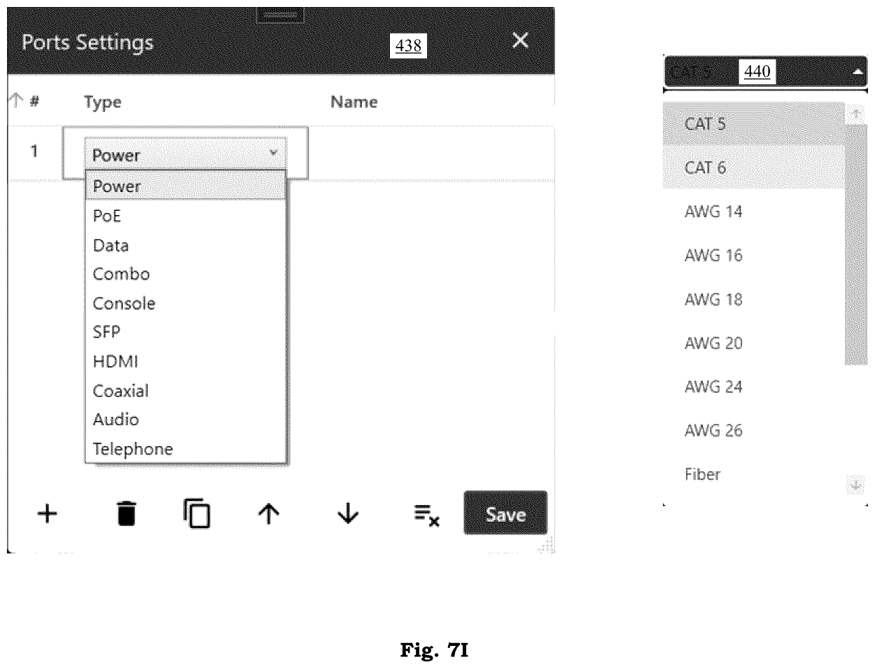

For completeness, FIG. 7 shows various screenshots from an exemplary implementation of the present technology. The screenshots capture various aspects of creating and updating of a low-voltage schematic diagram. Per above, the low-voltage schematic diagram is preferably created with the aid of a schematic module of an instant low-voltage system/plugin.

More specifically, FIG. 7A shows a screenshot section/portion 400 with a PoE switch device 402A under an overload condition (i) as indicated by a fully extended dial 402B and a warning dial symbol 402C on the device. The device is overloaded because its existing load is 113 W (15 W (intrinsic load)+8 W+45 W+45 W=113 W) while it has a rated maximum load or capacity of 100 W as shown.

FIG. 7B shows a screenshot section/portion presenting a grouping capability of the instant system/plugin where a number of devices have been grouped together into a group 410. Note, that the group is overloaded because switch 412A is under both overload conditions (i) and (ii) as shown by alert symbols 412B and 412C respectively per above teachings.

FIG. 7C shows dialog box 414 that is used to add a new device to a schematic diagram. Note that the various specifications including power/load ratings and ports for the device can be configured via the various input boxes provided. FIG. 7D shows a dialog box 418 that is used to add a new PoE driver to the schematic diagram. Note the various configuration options with which the user can create/update the specifications of the driver as needed.

FIG. 7E, FIG. 7F and FIG. 7G show views of a dialog box 424 for adding a new PoE switch. Again, note the various input boxes for setting/updating the specifications for the device. Specifically note that input box 426 can be used to set the type of current i.e. alternating current (AC) versus direct current (DC) for the device, and input box 428 can used to set the number of power inputs i.e. whether single or dual input ports. FIG. 7G shows a menu 430 for setting/updating the port configuration of the switch as shown. FIG. 7H shows the newly added switch 432 with the configured specifications. FIG. 71 show menus 438 and 440 for selecting various types of ports for devices and cable-types for the connections in a schematic diagram respectively.

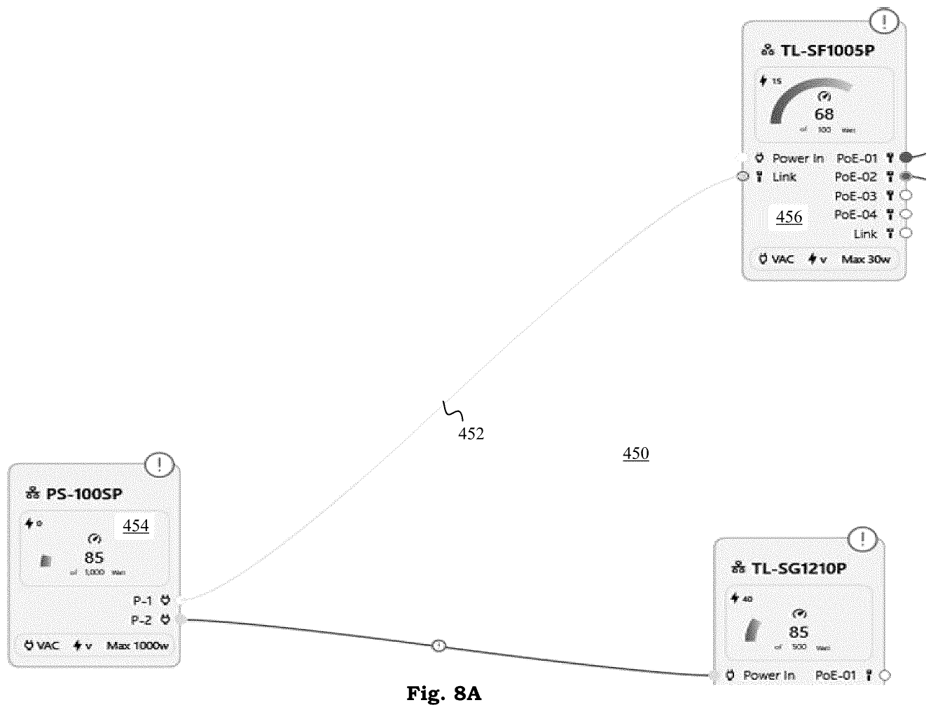

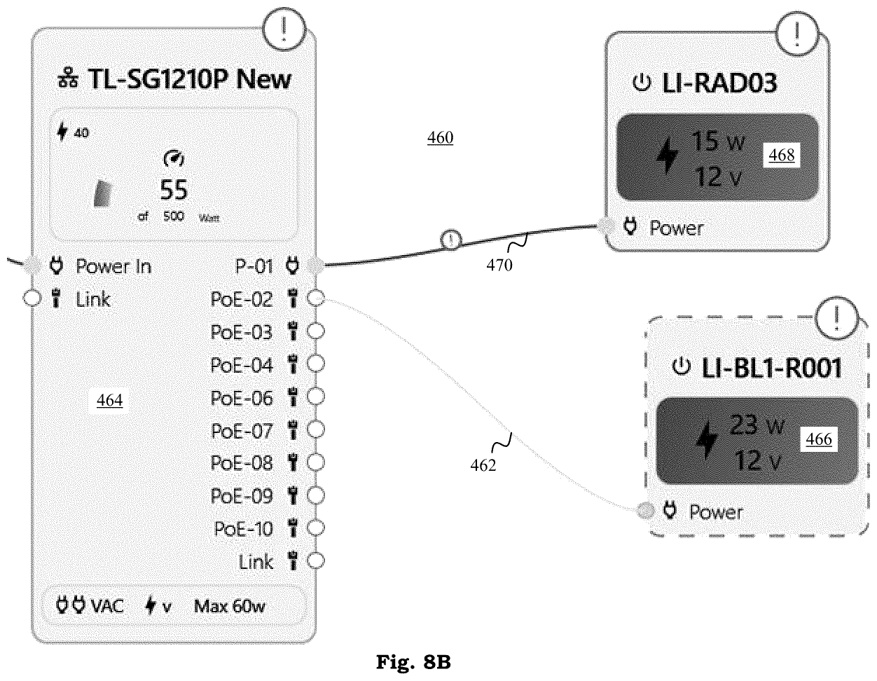

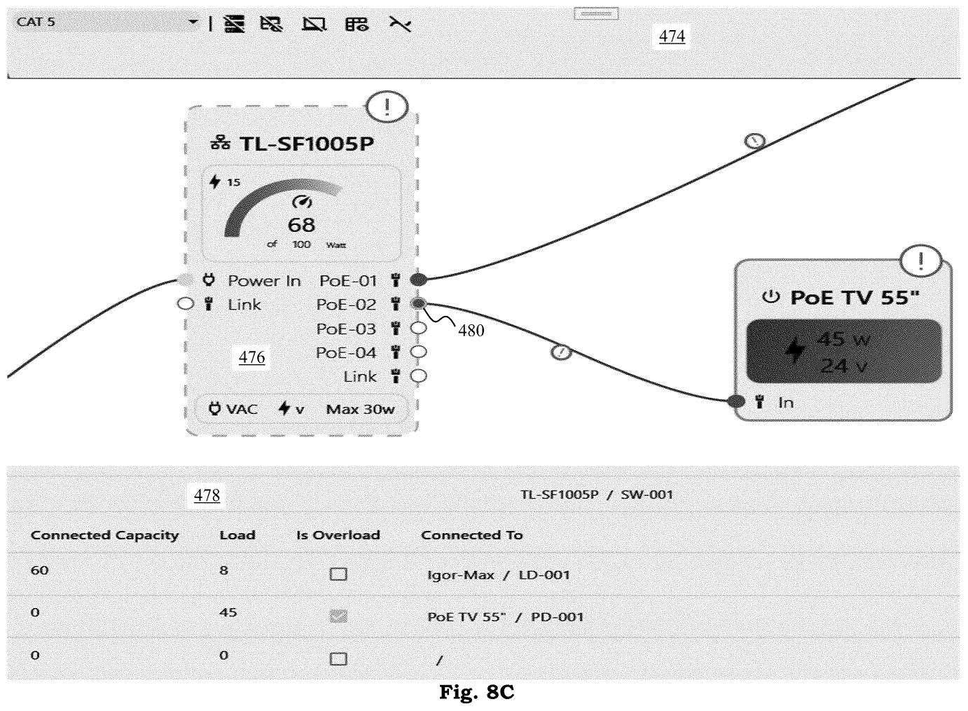

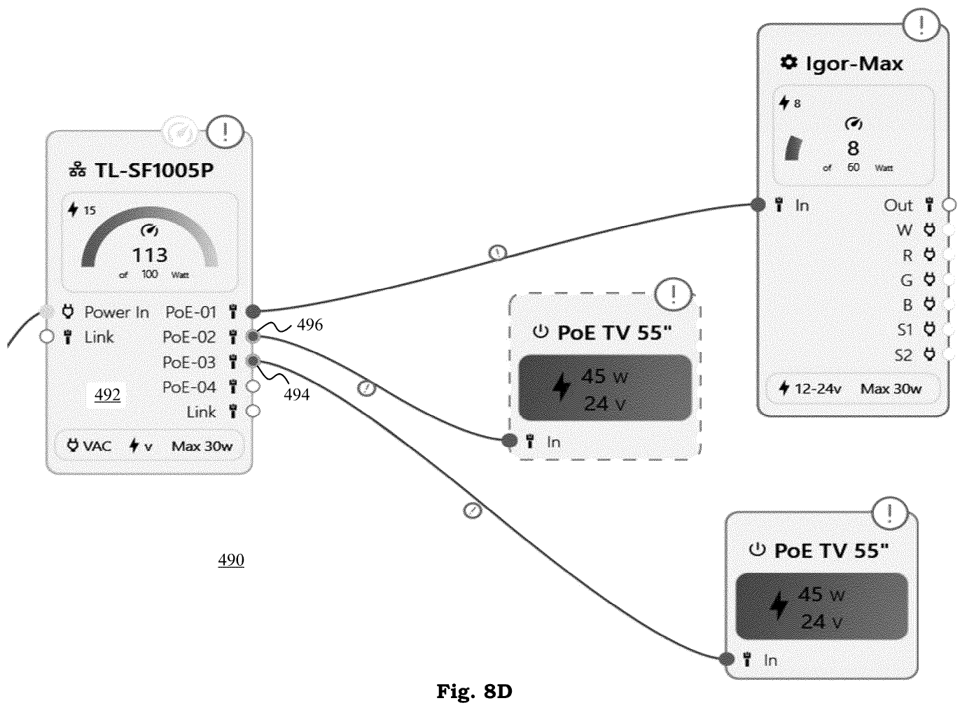

Finally, screenshot sections of FIG. 8 show various other error detection capabilities of the instant low-voltage design system in addition to the ones discussed above, and as afforded by its many embodiments. Specifically, FIG. 8A shows a screenshot section 450 in which connection 452 is under error because a power output of power supply 454 is being connected to a Link input of switch 456. This is an error and connection 452 is shown in red color on the screen.

FIG. 8B shows a screenshot section 460 in which connection 462 is in error and shown in red color because a PoE output port of switch 464 is being used to drive a power input of low-voltage lighting device/equipment 466. This is in error because port PoE-02 of switch 464 is incompatible with the cable selected for connection 462. More specifically, the cable selected for connection 462 is an AWG cable that is incompatible with port PoE-02, which is an RJ-45 port capable of accepting CAT-5, CAT-6, CAT-7 and the like cables.

FIG. 8C shows a screenshot section 474 in which one port of PoE switch 476 is overloaded as shown. Port PoE-02 is overloaded because it has a maximum load capacity of 30 W while it is being used to drive a PoE TV 55″ device that has a rating of 45 W. In FIG. 8C this overload condition is also shown in a table 478 presented on the GUI. In table 478, the row for PoE TV 55″ causing the overload condition is shown by a checked “Is Overload” box as shown. Furthermore, the connection causing the overload condition has a circle 480 that is shown in red on the implicated output port PoE-02 of device 476. FIG. 8D shows a screenshot portion 490 in which device 492 is under overload condition (i) because of two overloaded connections as indicated by circles 494 and 496 that are causing the overload condition.

Other devices supported by the instant low-voltage design system include controller devices or control switches in a low-voltage PoE system. Such controllers are typically installed on walls as mechanical or touchscreen operated switches that are used to control the flow of power to the endpoint lighting equipment or lighting devices. As such, they are installed in between a PoE driver and the lighting equipment. In the instant low-voltage design system, the connections from a controller or a control device to the endpoint lighting devices is preferably shown with a dashed line on the schematic diagram.

In view of the above teachings, a person skilled in the art will recognize that the methods of present invention can be embodied in many different ways in addition to those described without departing from the principles of the invention. Therefore, the scope of the invention should be judged in view of the appended claims and their legal equivalents.

What is claimed is:

1. A computer system comprising computer-readable instructions stored in a non-transitory storage medium and at least one microprocessor coupled to said non-transitory storage medium for executing said computer-readable instructions, said at least one microprocessor configured to:
(a) enable a user to interactively create a schematic diagram and a corresponding three-dimensional (3D) model of a low-voltage system for a building, wherein said schematic diagram comprises a connection between a port on a first device and a port on a second device;
(b) perform an integration of said schematic diagram with said 3D model by associating said first device, said second device and said connection to their corresponding counterparts in said 3D model;
(c) automatically identify in said 3D model based on said integration, said port on said first device from amongst a set of ports on said first device and said port on said second device from amongst a set of ports on said second device;
(d) perform a routing in said 3D model of a cable with an associated cable-type for forming said connection, said connection realized by installing said cable in said building;
(e) enable said user to interactively perform a modification of said schematic diagram and said 3D model for alleviating a voltage-drop based on said cable-type and a length of said cable; and
(f) perform a load analysis of said low-voltage system and alert said user if a potential load on any of said first device and said second device is expected to exceed a rated maximum value.

2. The computer system of claim 1, wherein said at least one microprocessor is further configured to perform said routing one of manually and automatically.

3. The computer system of claim 1, wherein said modification performed by said user comprises selecting a different cable-type for said cable, reducing a length of said cable and replacing one or both of said first device and said second device.

4. The computer system of claim 1, wherein said low-voltage system is one of a Power over Ethernet (PoE) system, a fault managed power (FMP) system, a distributed antenna system (DAS), a closed-circuit television (CCTV) system, a fire-alarm system, a paging system, an audio-visual (A/V) system, a data network, a secure entry system and a physical intrusion detection system (IDS).

5. The computer system of claim 1, implemented as an add-in for a building information modeling (BIM) system.

6. The computer system of claim 1, wherein said BIM system is Autodesk Revit®.

7. The computer system of claim 1, wherein said at least one microprocessor is further configured to enable said user to generate a bill of materials (BOM) for said low-voltage system, said BOM comprising said first device, said second device and a length of said cable with associated cable-type.

8. The computer system of claim 1, wherein a digital asset comprising said 3D model and one or more datapoints are imported into a building monitoring system (BMS) for a real-time identification of an incident associated with any of said first device and said second device.

9. The computer system of claim 8, wherein a maintenance worker performs a resolution of said incident, and wherein said user modifies said schematic diagram and said 3D model based on said resolution.

10. The computer system of claim 1, wherein said first device and second device are selected from the group of devices including low-voltage power supplies, Power over Ethernet (PoE) switches, PoE drivers, low-voltage lighting equipment, PoE injectors and PoE appliances.

11. A computer-implemented method comprising the steps of:
(a) interactively creating by a user, a schematic diagram and a corresponding three-dimensional (3D) model of a low-voltage system for a building, said low-voltage system comprising a connection between a port on a first device and a port on a second device;
(b) integrating said schematic diagram with said 3D model by associating said first device, said second device and said connection to their corresponding counterparts in said 3D model;
(c) automatically identifying in said 3D model based on said integration, said port on said first device from amongst a set of ports on said first device and said port on said second device from amongst a set of ports on said second device;
(d) routing in said 3D model, a cable with an associated cable-type for forming said connection, said connection realized by installing said cable in said building;
(e) interactively modifying by said user, said schematic diagram and said 3D model for alleviating a voltage-drop based on said cable-type and a length of said cable; and
(f) performing a load analysis of said low-voltage system and alerting said user if a potential load on any of said first device and said second device is expected to exceed a rated maximum value.

12. The computer-implemented method of claim 11, performing said routing one of manually and automatically.

13. The computer-implemented method of claim 11, interactively performing said modifying by said user by one or more of selecting a different cable-type for said cable, reducing a length of said cable and replacing one or both of said first device and said second device.

14. The computer-implemented method of claim 11, wherein said low-voltage system is one of a Power over Ethernet (PoE) system, a fault managed power (FMP) system, a distributed antenna system (DAS), a closed-circuit television (CCTV) system, a fire-alarm system, a paging system, an audio-visual (A/V) system, a data network, a secure entry system and a physical intrusion detection system (IDS).

15. The computer-implemented method of claim 11 deployed as a plugin for a building information modeling (BIM) system.

16. The computer-implemented method of claim 15, wherein said BIM system is Autodesk Revit®.

17. The computer-implemented method of claim 11, generating by said user, a bill of materials (BOM) for said low-voltage system, said BOM comprising said first device, second device and a length of said cable with associated cable-type.

18. The computer-implemented method of claim 11, integrating with a building monitoring system (BMS) by importing one or more datapoints and a digital asset comprising said 3D model in said BMS, and identifying an incident associated with any of said first device and said second device in real-time.

19. The computer-implemented method of claim 18, resolving said incident by a maintenance worker, and modifying by said user, said schematic diagram and said 3D model in accordance with said resolution.

20. The computer-implemented method of claim 11, wherein said first device and second device are selected from the group of devices including low-voltage power supplies, Power over Ethernet (PoE) switches, PoE drivers, low-voltage lighting equipment, PoE injectors and PoE appliances.
